(19) United States
(12) Patent Application Publication
(10) Pub. No.: US 2025/0305355 A1
(43) Pub. Date: Oct. 2, 2025

(54) Door Stopping Device

(71) Applicant: Christian Mojica, Lehigh Acres, FL (US)

(72) Inventor: Christian Mojica, Lehigh Acres, FL (US)

(21) Appl. No.: 18/991,979

(22) Filed: Dec. 23, 2024

Related U.S. Application Data
(60) Provisional application No. 63/570,290, filed on Mar. 27, 2024.

(51) Int. Cl. E06B 7/36; E05F 5/08

(52) U.S. Cl. CPC E06B 7/36; E05F 5/08; E05Y 2201/224

(57) ABSTRACT

A door stopping device is disclosed for preventing doors from closing abruptly and/or unexpectedly and for prohibiting injury to individuals or pets. The door stopping device comprises a base component with a rectangular shaped mounting plate and an automatic spring-loaded stopping design. Further, a rotating arm, a protective sleeve, and spring-loaded mechanism components are housed in a cylinder-shaped casing secured to the base component mounting plate. The device remains engaged after automatic deployment until it has been manually reset with the reset button or mechanism situated at one end of the cylindrical tube. Additionally, the device is easy to install to any door frame or solid surface for enhanced safety in a variety of settings.

### CROSS-REFERENCE TO RELATED APPLICATION

The present application claims priority to, and the benefit of, U.S. Provisional Application No. 63/570,290, which was filed on Mar. 27, 2024, and is incorporated herein by reference in its entirety.

### FIELD OF THE INVENTION

The present invention relates generally to the field of door stopping devices. More specifically, the present invention relates to an improved a door stopping device with an automatic stopper design and a spring-loaded mechanism to prevent doors from closing abruptly and/or unexpectedly, avoiding potential injuries to fingers, hands, toes, paws, or tails of children and pets. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in door stopping devices. Generally, children and pets are at risk of getting fingers, hands, toes, paws, tails, or other body parts caught in doors. A significant risk of potential injury is placed on individuals (i.e., when entering or exiting doors while carrying items) when the user's ability is limited to prevent a door from abruptly closing. Further, individuals or domestic animals may be at risk for incurring potentially serious injuries during such basic daily living activities.

Additionally, this device is not limited to preventing potential injury to children and pets; it includes individuals that are disabled, have limited strength, elderly, recovering from surgery, or other medical conditions that may increase the potential for injury when entering or exiting through a doorway when a door closes unexpectedly or abruptly. At such times, if a door stopping device is available that enables users to freely open and close a door or enter and exit a doorway, they can traverse with ease in the home, work environment, building, or other facility. When individuals can move freely in a space without concern for injury and are confident their home is pet and children friendly, it provides a sense of security and peace of mind for family members.

Accordingly, there is a demand for an improved door stopping device that prevents a door from abruptly and/or unexpectedly closing on individuals or pets and thereby protects from serious injury. More particularly, there is a demand for a door stopping device that is easy to use and install while still maintaining the ability to provide protection against potential injury.

Therefore, there exists a long-felt need in the art for a door stopping device that protects users from injury from a door. There is also a long-felt need in the art for a door stopping device that comprises a spring-loaded mechanism that deploys automatically to keep the door slightly ajar, ensuring the door remains open. Further, there is a long-felt need in the art for a door stopping device that requires a manual reset for safety. Moreover, there is a long-felt need in the art for a device that has a protective covering, such as rubber or plastic, to prevent damage to door finishes. Further, there is a long-felt need in the art for a door stopping device that has a mounting plate for secure installation. Finally, there is a long-felt need in the art for a door stopping device with a child and pet proof design, making it an ideal solution for enhancing safety in a variety of settings.

The subject matter disclosed and claimed herein, in one embodiment thereof, comprises a door stopping device. The device is a specialized stopper designed to prevent doors from closing abruptly and unexpectedly and thereby prohibiting injury to individuals and pets. The door stopping device comprises a base component with a rectangular-like shaped mounting plate made from a metal or sturdy material to provide secure attachment and installation. The mounting plate has at least one through opening to secure the device to a wall, door frame, or other solid surface known in the art. Further, a spring-loaded mechanism component is attached to the mounting plate, providing case of installation. Additionally, a rotating arm component, with a protective cover, is attached to the spring-loaded mechanism to prevent damage to door finishes. Accordingly, the device enhances safety in various settings. The device also accounts for design aesthetics and can be manufactured in a variety of colors.

In this manner, the door stopping device of the present invention accomplishes all of the foregoing objectives and provides users with a device that reduces potential injuries when a door shuts abruptly and/or unexpectedly. The device has a spring-loaded mechanism that deploys automatically and prevents doors from closing abruptly and/or unexpectedly on individuals or pets, causing potential injury. The device is designed with a durable, flat surfaced back side mounting plate for secure and easy installation to door frames or another solid surface.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a door stopping device. The device is a door stopping device configured to automatically stop a door from slamming or shutting abruptly/unexpectedly thereby preventing potential injury. The door stopping device comprises a body component that includes a rectangular-like mounting plate with at least one through opening at the top of the mounting plate and at least one through opening at the bottom of the mounting plate for secure installation. The through opening in the mounting plate is used to secure the device to a wall, door frame, or other solid surface used in the field. Further, a spring-loaded mechanism component is secured to the mounting plate that includes at least one through opening. The device can be attached to a variety of surfaces using a variety of fasteners, to prevent injuries occurring from doors closing unintentionally. Additionally, the rotating arm component may include a protective rubber or plastic cover to prevent damage to door finishes. Further, the device has a child-proof design for enhanced safety. The device can also be manufactured in a variety of colors to coordinate with the design of any home, office environment, clinic, school, or other setting. Accordingly, the device provides a solution to prevent potential injuries when doors close abruptly and/or unexpectedly at school, in daycares, medical facilities, and in the home. Further, the device is easy to use and install for added safety.

In one embodiment, the door stopping device is made up, at a minimum, of the following components: a base component, a mounting plate, at least one through opening at the top of the mounting plate, at least one through opening at the bottom of the mounting plate, a spring-loaded mechanism, a childproof design, a rotating arm, and a protective sleeve to prevent damage to doors and door frames. Optional items may be added to create additional functionality or increase safety, as needed.

In one embodiment, the base component is most often manufactured from a metal material that is durable and that can withstand the weight and size of various doors. In some instances, the base component can be manufactured of different materials such as aluminum, steel, or any combination thereof. The corners of the mounting plate of the base component are formed in such a way that there are no sharp or protruding edges that might get caught on loose clothing or other items and potentially cause injury to individuals passing through a doorway. Further, the back side of the mounting plate is a flat surface to ensure secure installation and support.

In one embodiment, the base component has dimensions such that it will attach to a standard size door frame or solid surface for residential or commercial doors. Typically, doors, door frames, and solid surfaces in the home or office are a standard size, enabling the door stopping device to be installed with case in most environments.

In one embodiment, the base component device is manufactured with multiple size mounting plates to accommodate doors, door frames, and solid surfaces that are not a typical size. The door stopping device is not limited to the use of standard size doors and door frames; the device may be manufactured to secure to any solid surface. Further, the size of the mounting plate can vary such that it is suitable for a variety of door sizes and weight.

In one embodiment, the base component comprises a mounting plate with at least one through opening. Typically, at least one through opening is located at the top of the device, and at least one through opening is located at the base of the device. The base component is mounted to a door frame or other solid surface using at least one fastener. Optionally, the fasteners can be any fastener known in the art, such as screws, nails, rivets, anchors, or any other known fastener. Generally, fasteners are used to secure the base component mounting plate to a door frame or solid surface by means of at least one through opening at the top of the mounting plate surface and at least one through opening at the bottom of the mounting plate surface for optimal support. The present device can be installed using fasteners at the top of the mounting plate and at the bottom of the mounting plate to ensure that the device is safe and secure.

In one embodiment, a spring-loaded mechanism is attached to the base component mounting plate. The spring-loaded mechanism is preferably encapsulated in a cylinder or tubular shaped component of the device. Further, the spring-loaded mechanism automatically deploys to keep the door slightly ajar, helping to prevent potential injury to users, such as damage to fingers, arms, toes, paws, tails, or other body appendages. Moreover, the automatic deployment of the spring-loaded mechanism assists in the prevention of injury to pets and small children. Further, once the spring-loaded mechanism is deployed, the door will remain open until the device is reset.

In one embodiment, the cylinder or tubular shaped component comprises a button, knob, switch, or other lever known in the art to reset the device. Further, once the spring-loaded mechanism on the door stopping device is deployed, users prefer the door to remain ajar until such a time it is deemed safe for the door to close. Generally, an adult or user with an extended reach can reset the device with case.

In one embodiment, the cylinder or tubular shaped component of the device has a rotating arm mechanism projecting from the top. Typically, the rotating arm is in the cylinder-shaped component. Further, the rotating arm on the device acts as a wedge to keep the door open, preventing potential injury. Further, in another embodiment, the cylinder-shaped component serves as a hinge, pivot, axis point, or other joint known in the art to deploy the spring-loaded mechanism and enable the arm or extension to cause the door to remain open, preventing potential injury.

In one embodiment, the device may include a protective cover on the furthest end of the rotating arm to prevent damage to door finishes or other surfaces. The protective cover is preferably manufactured from rubber, silicone, or other material known in the art. The protective cover component can be any suitable shape and size to fit securely on the rotating arm component. Specifically, the protective cover is positioned over the rotating arm, which rests on the surface of the door when the device is deployed. The protective cover, which acts to preserve the door or other surface, does not interfere with the motion or deployment of the device.

In yet another embodiment, the door stopping device comprises a plurality of indicia.

In yet another embodiment, a method of installing and using the door stopping device is disclosed. The method includes the steps of providing a door stopping device comprising a base component with a mounting plate, a spring-loaded mechanism component, a rotating arm component, and a protective sleeve component. The method also comprises securing the device to a door frame or other solid surface. Further, the method comprises deploying the device. Finally, the method comprises resetting the device.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the door stopping device of the present invention in accordance with the disclosed architecture;

FIG. 2 illustrates a perspective view of one embodiment of the door stopping device of the present invention showing a top view of the device in accordance with the disclosed architecture;

FIG. 3 illustrates a perspective view of one embodiment of the door stopper device of the present invention showing the device mounted to a door frame in accordance with the disclosed architecture;

FIGS. 4A-E illustrate a perspective view of one embodiment of the door stopping device of the present invention showing the device installed and in various colors in accordance with the disclosed architecture; and

FIG. 5 illustrates a flowchart showing the method of using one potential embodiment of a door stopping device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a door stopping device that provides enhanced protection to users and pets from being potentially injured by a door that closes abruptly and/or unexpectedly. There is also a long-felt need in the art for a door stopping device that prevents an appendage from becoming caught or damaged in a door closing abruptly and/or unexpectedly. There is also a long-felt need in the art for a door stopping device that comprises a spring-loaded mechanism that deploys automatically to keep the door slightly ajar, ensuring the door remains open. Further, there is a long-felt need in the art for a door stopping device that requires a manual reset for safety. Moreover, there is a long-felt need in the art for a device that has a protective rubber covering to prevent damage to door finishes. Further, there is a long-felt need in the art for a door stopping device that has a mounting plate for easy and secure installation. There is also a long-felt need in the art for a door stopping device that can be secured to a variety of solid surfaces. Moreover, there is a long-felt need in the art for a door stopping device that can be manufactured in a variety of sizes for residential or commercial use. Finally, there is a long-felt need in the art for a door stopping device with a child-proof design, making it an ideal solution for enhancing safety in a variety of settings, such as homes, daycares, clinics, schools, and others known in the art.

The present invention, in one exemplary embodiment, is a novel door stopping device. The device deploys automatically, preventing potential serious injury to users and pets. The door stopping device comprises a base component with a mounting plate and at least one through opening at the top and at the bottom of the mounting plate. Further, a cylinder or tubular component to house the spring-loaded mechanism, a rotating arm component, and a protective rubber sleeve component. The device can be secured to a door frame or other solid surface. Additionally, the door remains open until the device is reset, providing added security. Further, the protective sleeve component fits securely over the rotating arm to prevent damage to door finishes.

The present invention also includes a method of preventing doors from closing abruptly and/or unexpectedly causing potential injury. The method includes providing a door stopping device comprised of a base component with a mounting plate with at least one through opening, a spring-loaded mechanism component, rotating arm component, and a protective covering component. The method also comprises installing the component to a solid surface. Further, the method comprises an automatic deployment of the device. Finally, the method comprises easily resetting the device.

Accordingly, the door stopping device of the present invention is particularly advantageous as it provides a device that prevents a door from closing abruptly and/or unexpectedly. More specifically, the door stopping device reduces the potential for injury among small children and pets. Furthermore, the door stopping device is not limited to reducing potential injury to children and pets, but additionally to individuals with a disability, elderly, recovering from surgery, or previously injured. Moreover, the door stopping device is easy to install and can be manufactured to accommodate doors varying in size. In this manner, the door stopping device provides a universal solution to doors abruptly and/or unexpectedly closing and causing potential injury.

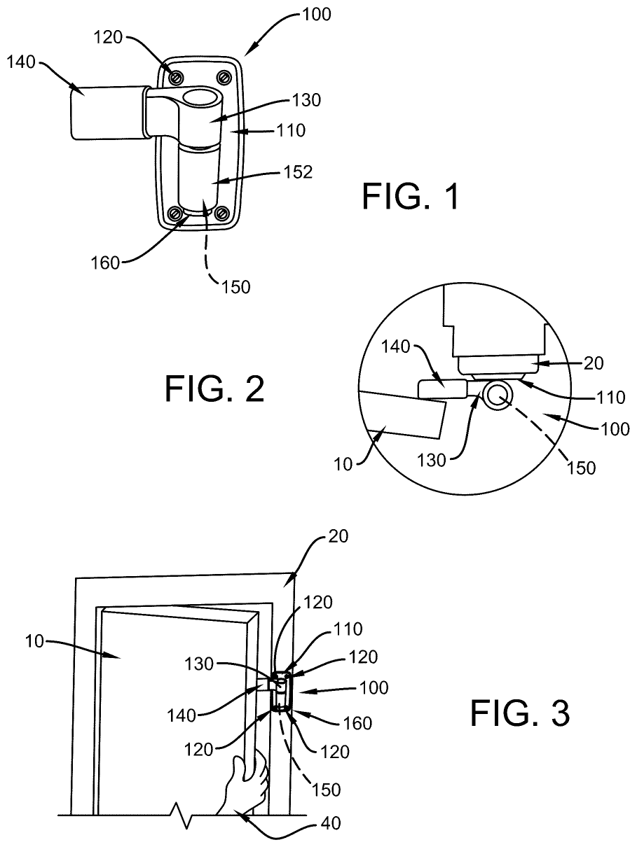

Referring initially to the drawings, FIG. 1 illustrates a perspective view of one embodiment of the door stopping device 100 of the present invention. In the present embodiment, the door stopping device 100 is an improved door stopping device 100 that prevents a door from closing abruptly and/or unexpectedly and thereby prohibits potential injury. The door stopping device 100 is most often manufactured of steel, aluminum, or other metal known in the art. Specifically, the door stopping device 100 comprises a mounting plate component 110 with at least one through opening 120, a rotating arm component 130, a protective sleeve component 140, a spring-loaded mechanism component 150, and a reset button or mechanism component 160. The device 100 has a flat surfaced mounting plate component 110 with at least one through opening 120 for installation. Further, the spring-loaded mechanism 150 is located inside the cylinder casing component 152. Moreover, the rotating arm component 130 can pivot forward to engage the device 100 or backward (i.e., rearward) when the device 100 is not engaged. Further, the protective sleeve 140 component securely fits on the rotating arm 130 to prevent damage to door 10 finishes. Finally, a reset button or mechanism 160 is located at the bottom of the cylinder casing component 152 to disengage (i.e., actuate) the device 100. Accordingly, the device 100 reduces the potential injury to individuals or pets when a door 10 closes abruptly and/or unexpectedly. Optional items may be added to create additional functionality or increase safety, as needed.

FIG. 2 illustrates a perspective view of one embodiment of the door stopping device 100 of the present invention from a top view. Specifically, the door stopping device 100 is securely attached to a door frame 20 by way of the mounting plate component 110. Further, the rotating arm component 130 fitted with the protected sleeve component 140, is engaged and resting on the door 10. The protective sleeve 140 can be manufactured of rubber, plastic, silicone, or other material known in the field. Moreover, the spring-loaded mechanism component 150 has been automatically deployed to prevent the door 10 from closing abruptly and causing potential injury to individuals or pets. Accordingly, the device 100 reduces the potential for injury, creating an ideal solution for enhancing safety in various settings.

Furthermore, the door stopping device 100 can be manufactured in a variety of colors and is not limited to one color. Typically, users of the device 100 may select a variety of colors to enhance the aesthetics of the home, workspace, or other environment. Further, the device 100 may be manufactured in a various size to accommodate doors of varying weight, material, height, and width. In this manner, the door stopping device 100 provides enhanced safety.

FIG. 3 illustrates a perspective view of one embodiment of the door stopper device 100 of the present invention installed on a door frame 20. Specifically, the door stopping device 100 is engaged and securely attached to a door frame 20. Further, the mounting plate 110 with at least one through opening 120 is securely installed on a door frame 20. Moreover, the door 10 is ajar with the rotating arm 130 engaged, blocking the door 10 from closing. In this manner, the door stopping device 100 prevents potential injury to individuals and pets. Further, the clearance between the door 10 opening and the frame 20 is wide enough for a user's 40 hand to comfortably fit in the gap. Typically, a user 40 will reset the device 100 using the reset button or mechanism 160 when it is deemed safe.

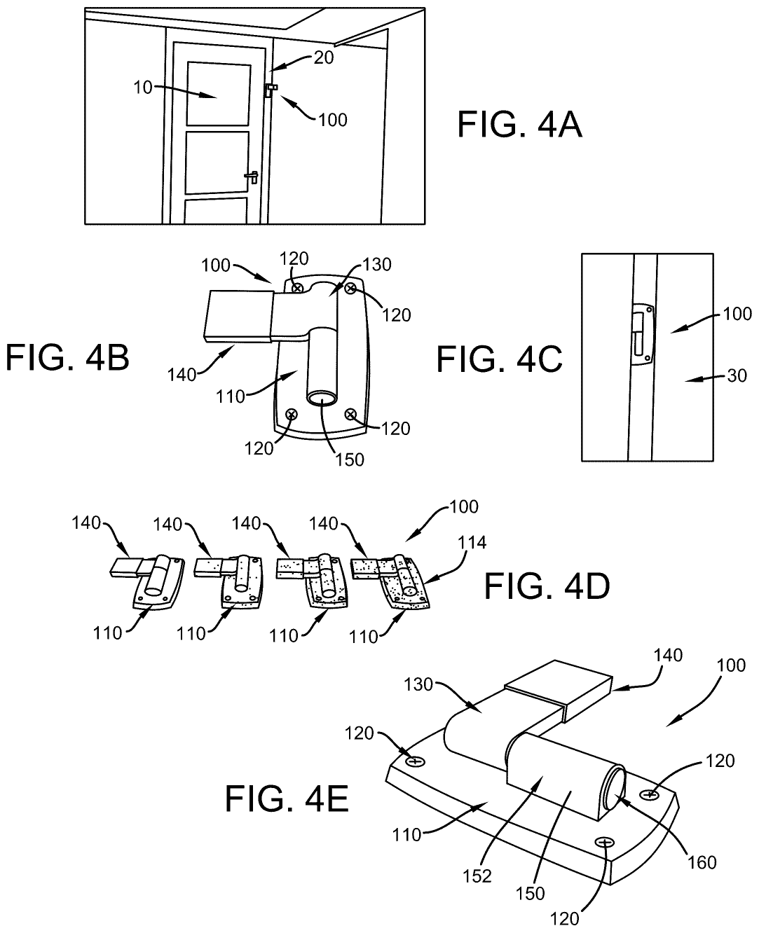

As shown in FIGS. 4A, 4B, 4C, 4D, 4E, in yet other embodiments, the door stopping device 100 comprises a plurality of shades 114. The mounting plate 110 component of the device 100 and the rotating arm 130 protruding from the cylinder-shaped component 152 may be manufactured or painted in a plurality of shades 114. Specifically, any suitable shade as is known in the art can be included, such as, but not limited to, white, silver, black, or bronze.

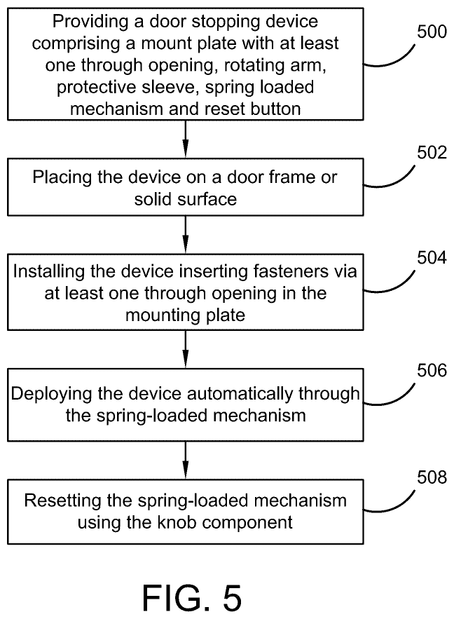

FIG. 5 illustrates a flowchart of the method of using the door stopping device. The method includes the steps of at 500, providing a door stopping device comprising a mounting plate with at least one through opening, rotating arm, protective sleeve, spring-loaded mechanism, and reset button or mechanism. The method also comprises at 502, placing the device on a door frame or solid surface. Further, the method comprises at 504, installing the device inserting fasteners via at least one through opening in the mounting plate component such that it is secured to the door frame or solid surface. The method also comprises at 506, deploying the device automatically through the spring-loaded mechanism. Finally, the method comprises at 508, resetting the spring-loaded mechanism using the knob component.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “door stopping device”, “door stopper device”, and “device” are interchangeable and refer to the door stopping device 100 of the present invention.

Notwithstanding the foregoing, the door stopping device 100 of the present invention can be of any suitable size and configuration as is known in the art without affecting the overall concept of the invention, provided that it accomplishes the above-stated objectives. One of ordinary skill in the art will appreciate that the door stopping device 100 as shown in FIGS. 1-5 is for illustrative purposes only, and that many other sizes and shapes of the door stopping device 100 are well within the scope of the present disclosure. Although the dimensions of the door stopping device 100 are important design parameters for user convenience, the door stopping device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A door stopping device comprising:
a door stopper;
a mounting plate;
a rotating arm;
a casing component;
a spring; and
a reset mechanism;
wherein said rotating arm pivotable in said casing component;
wherein said mounting plate having at least one through opening for receiving at least one fastener;
wherein said mounting plate is a flat surface mounting component;
wherein said mounting plate is attached to a door frame with said at least one fastener mounted to the door frame;
wherein said spring positioned inside said casing component;
wherein said rotating arm having a forward pivotal engagement position and a rearward pivotal disengagement position; and
further wherein said forward pivotal engagement position prohibiting a door from mating with the door frame.

2. The door stopping device of claim 1, wherein said casing component is a cylindrical casing component.

3. The door stopping device of claim 2 further comprising a sleeve, wherein said sleeve secured around said rotating arm for protecting a finish of a door.

4. The door stopping device of claim 3, wherein said reset mechanism is an actuation button positioned at a bottom of said casing component to disengage said door stopper.

5. The door stopping device of claim 4, wherein said sleeve having a material selected from the group consisting of a rubber, a plastic, and a silicone.

6. The door stopping device of claim 5, wherein said reset mechanism actuates said spring for releasing said rotating arm to move from said forward pivotal engagement position to said rearward pivotal disengagement position.

7. The door stopping device of claim 6, wherein said door stopper having a material selected from the group consisting of a steel and an aluminum.

8. A door stopping device comprising:
a door stopper;
a mounting plate;
a rotating arm;
a casing component;
a spring; and
a reset mechanism;
wherein said rotating arm pivotable in said casing component;
wherein said mounting plate having at least one through opening for receiving at least one fastener;
wherein said mounting plate is a flat surface mounting component;
wherein said mounting plate is attached to a door frame with said at least one fastener mounted to the door frame;
wherein said spring is positioned inside said casing component;
wherein said rotating arm having a forward pivotal engagement position and a rearward pivotal disengagement position;
wherein said forward pivotal engagement position prohibiting a door from mating with the door frame; and
further wherein said reset mechanism is an actuation button positioned at a bottom of said casing component to disengage said door stopper.

9. The door stopping device of claim 8, wherein said casing component is a cylindrical casing component.

10. The door stopping device of claim 9 further comprising a sleeve, wherein said sleeve secured around said rotating arm for protecting a finish of a door.

11. The door stopping device of claim 10, wherein said sleeve having a material selected from the group consisting of a rubber, a plastic, and a silicone.

12. The door stopping device of claim 11, wherein said reset mechanism actuates said spring for releasing said rotating arm to move from said forward pivotal engagement position to said rearward pivotal disengagement position.

13. The door stopping device of claim 8, wherein said reset mechanism actuates said spring for releasing said rotating arm to move from said forward pivotal engagement position to said rearward pivotal disengagement position.

14. The door stopping device of claim 13, wherein said door stopper having a material selected from the group consisting of a steel and an aluminum.

15. A door stopping device comprising:
a door stopper;
a mounting plate;
a rotating arm;
a casing component;
a spring; and
a reset mechanism;
wherein said rotating arm pivotable in said casing component;
wherein said mounting plate having at least one through opening for receiving at least one fastener;
wherein said mounting plate is a flat surface mounting component;
wherein said mounting plate is attached to a door frame with said at least one fastener mounted to the door frame;
wherein said spring is positioned inside said casing component;
wherein said rotating arm having a forward pivotal engagement position and a rearward pivotal disengagement position;
wherein said forward pivotal engagement position prohibiting a door from mating with the door frame;
wherein said reset mechanism is an actuation button positioned at a bottom of said casing component to disengage said door stopper; and
further wherein said reset mechanism actuates said spring for releasing said rotating arm to move from said forward pivotal engagement position to said rearward pivotal disengagement position.

16. The door stopping device of claim 15, wherein said casing component is a cylindrical casing component.

17. The door stopping device of claim 16 further comprising a sleeve, wherein said sleeve secured around said rotating arm for protecting a finish of a door.

18. The door stopping device of claim 17, wherein said sleeve having a material selected from the group consisting of a rubber, a plastic, and a silicone.

19. The door stopping device of claim 18, wherein said door stopper having a material selected from the group consisting of a steel and an aluminum.

20. The door stopping device of claim 15 further comprising a sleeve, wherein said sleeve secured around said rotating arm for protecting a finish of a door.
